(19) United States
(12) Patent Application Publication
(10) Pub. No.: US 2009/0307399 A1
(43) Pub. Date: Dec. 10, 2009

(54) JOB-BASE STRUCTURE USING PROCESS AS DATA PROCESSING AND TRANSMITTING UNIT

(75) Inventor: WEN-SEN TSAI, Zhubei City (TW)

Correspondence Address: APEX JURIS, PLLC, 12733 LAKE CITY WAY NORTHEAST, SEATTLE, WA, 98125, US

(73) Assignee: ACCUSYS. INC., Zhubei City (TW)

(21) Appl. No.: 12/136,450

(22) Filed: Jun. 10, 2008

(51) Int. Cl. G06F 13/42

(52) U.S. Cl. 710/106

(57) ABSTRACT

The present invention discloses a job-based structure using a process as a data processing and transmission unit. The structure includes a main system, and a disk array system. The main system includes an interface controller connected to the disk array system. The disk array system includes a job queue controller, a PRD table controller, a DMA controller and a storage device connected through a DMA bus. The DMA controller executes an instruction transmitted through the interface controller according to a request of the main system, and the instruction is decomposed into a number of processes for the job queue controller to access a storage device sequentially. The accessed data is transmitted to the job queue controller in terms of processes and responded to the main system sequential. Therefore the invention can improve the processing efficiency of the main system.

### BACKGROUND OF THE INVENTION

1. Field of the Invention

The present invention relates to a job-based structure using process as data processing and transmitting unit, and more particularly to a job-based structure applied in a serial ATA disk array system for improving the data access efficiency of a computer system.

2. Description of the Related Art

As computer technologies develop rapidly, computer manufacturers keep pursuing hardware equipments with a faster computing speed and a higher performance. However, data access speed is also a key factor that affects the overall performance of computer hardware, in addition to the pursuance of fast speed and high performance. Even the most advanced hardware equipment cannot improve the overall performance of a computer system if there is no appropriate data access structure to go with the computer system.

With reference to FIG. 1, a structure comprises a main system 50 and a disk array system 60. The main system 50 further comprises a system processor 51, a system memory 52, and an interface controller 53 disposed at an end of the main system and supporting a serial advanced technology attachment (ATA) protocol. The system processor 51 issues an instruction to the disk array system 60 through the Serial ATA interface controller 53 to read/save data and returns the processed data to the system memory 52. The disk array system 60 is connected to the interface controller 53 of the main system 50 through a communication circuit 55. The disk array system 60 further comprises a disk array controller 61 and a plurality of disks 62, but the structure uses the Serial ATA interface as a channel for transmitting data in high speed. Although the data transmission rate can be improved, yet the disk array controller 61 needs to receive an instruction from the main system 50 to access data in the disk 62. Since some instructions execute simple processes and some execute a plurality of complicated processes, and all processes specified by the instruction must be completed before returning to the main system 50 when the disk array system 60 processes a more complicated instruction, therefore the performance of the main system cannot be improved effectively, because the main system 50 has to wait for the completion of all unfinished processes of the instruction, even though some processes of the instruction have been completed.

### SUMMARY OF THE INVENTION

In view of the shortcomings of the prior art, the inventor of the present invention based on years of experience in the related industry to conduct extensive researches and experiments, and finally developed a job-based structure using process as data processing and transmitting unit to overcome the aforementioned shortcomings and promote the development of the industry.

The primary objective of the present invention is to overcome the shortcomings of the prior art by providing a job-based structure that divides an instruction into a plurality of execution units (processes) for accessing a storage device when a main system executes the instruction.

Another objective of the present invention is to provide a job-based structure that returns to the main system on the first in first out (FIFO) basis after an access to the storage device is completed.

A further objective of the present invention is to carry out a compiler procedure of a PRD table controller before executing an instruction or transmitting data of an executed instruction, so as to improve the data conversion capability.

To achieve the foregoing objectives, the present invention provides a job-based structure using a process as a data processing and transmitting unit, comprising: a main system, and a disk array system, wherein the main system comprises an interface controller, a system processor and a system memory, and the interface controller, the system processor and the system memory are connected through a system bus, and the system processor issues a data access request to the disk array system through the interface controller according to a desired executing instruction, and saves the responded data into the system memory.

The disk array system is connected to the interface controller by a communication circuit, and the disk array system further comprises a codec, a receiver controller, a transmitter controller, a job queue controller, a PRD table controller, a direct memory access (DMA) controller and a storage device connected through a DMA bus. The codec executes an instruction transmitted from the main system through the interface controller, and the instruction has a format in compliance with the frame information structure (FIS), and performs a decoding procedure according to an 8b/10b coding mechanism. The receiver controller divides an instruction of a decoding procedure into a plurality of independent processing units (jobs). The transmitter controller responds the accessed data in terms of jobs to the main system. The job queue controller executes the desired executing jobs of an instruction or a processed data, and responds to the main system according to the queue order. After obtaining the control right of the system bus, the DMA controller starts accessing data or transmitting processed data processes to the job queue controller according to a sequence to wait for responding to the main system, and the job queue controller sequentially writes the desired executing processes into a DMA bus. The DMA bus is connected to a storage device, a memory controller or a PCI controller. The PRD table controller is provided for describing the transfer address and transfer count of the desired processing instruction and data. With the description of the PRD table controller, the DMA controller writes data to a connected storage device.

The present invention decomposes an instruction into a plurality of independently completing processes, and uses the process as a data processing and transmission unit, without requiring to wait for all processed of the instruction to be completed before returning to the main system, and thus the invention reduces the time of waiting for the completion of the instruction and improve the operating efficiency of the main system greatly.

To make it easier for our examiner to understand the objects, shape, characteristics and performance of the present invention, we used preferred embodiments accompanied with related drawings for the detailed description of the invention as follows.

### BRIEF DESCRIPTION OF THE DRAWINGS

FIG. 1 is a schematic view of a structure according to a prior art;

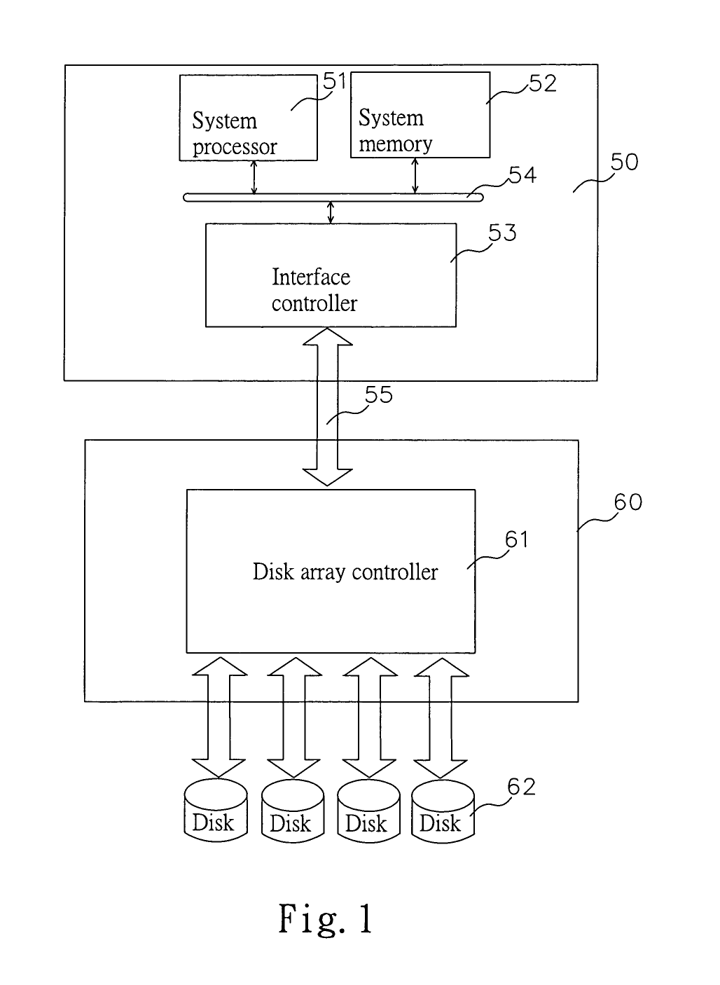

FIG. 2 is a schematic view of a structure according to the present invention;

FIG. 3 is a schematic view of a job queue arrangement according to the present invention;

FIG. 4 is a schematic view of operating a FIS pointer of a receiver controller according to the present invention;

FIG. 5 is a schematic view of operating a job queue pointer of a receiver controller according to the present invention; and

FIG. 6 is a flow chart of an operation using a process as a data processing and transmission unit according to the present invention.

### DETAILED DESCRIPTION OF THE PREFERRED EMBODIMENTS

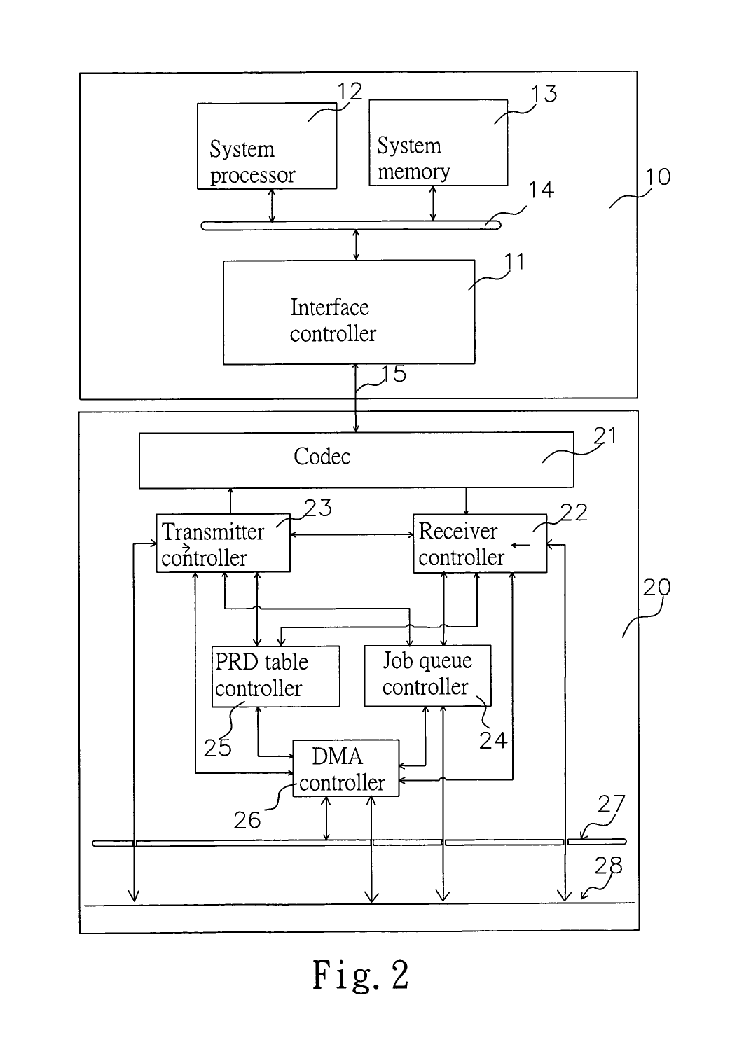

Referring to FIG. 2 for a schematic view of a job-based structure according to the present invention, the job-based structure comprises a main system 10 and a disk array system 20. The main system 10 includes an interface controller 11 (and this embodiment adopts an interface controller that supports the Serial ATA specification), a system processor 12, and a system memory 13. The interface controller 11, the system processor 12 and the system memory 13 are connected by a system bus 14, and the system processor 12 issues a data access request to the disk array system 20 through the interface controller 11 and responds the data stored in the system memory 13 according to the desired executing instruction.

The disk array system 20 is connected to the interface controller 11 through a communication circuit 15, and the disk array system 20 further comprises a codec 21, a receiver controller 22, a transmitter controller 23, a job queue controller 24, a PRD table controller 25, a DMA controller 26 and storage device (not shown in the figure, and this embodiment adopts a storage device that supports the Native Instruction Queuing (NCQ) protocol connected to a DMA bus 27.

The codec 21 executes an instruction transmitted from the main system 10 through the interface controller 11, and the instruction complies with the frame information structure (FIS) format for carrying out a decoding procedure according to an 8b/10b coding mechanism.

The receiver controller 22 decomposes the instruction after going through the decoding procedure into a plurality of independently completing job-based units (or processes.

The transmitter controller 23 responds an accessed data and responds the data to the main system 10 in terms of processes.

The job queue controller 24 arranges the desired executing instruction processes or the processed data of the instruction according to the sequence of processes of the data, and waits for the execution or responds to the main system 10.

After obtaining the control right of the DMA bus 27, the DMA controller 26 writes the desired executing processed arranged by the job queue controller 24 into the DMA bus 27, and starts accessing the accessed data or the processed of the processed data to the job queue controller 24 according to a sequence, and waits for the response to the main system 10, and the DMA bus 27 is connected to a storage device, a memory controller or a PCI controller (not shown in the figure).

The PRD table controller 25 describes the transfer address and the transfer count of the desired processing instruction and data, so that the data described by the DMA controller 26 can be written into a connected storage device.

The instruction obtained from the codec 21 by the receiver controller 22 complies with a frame information structure (FIS) format and decomposes the instruction into a plurality or processes, and the processes area arranged sequentially in the job queue controller 24, and the system processor 12 drives the DMA controller 26 to write the processed data into the connected storage device based on the transfer address and the transfer count described in the PRD table controller.

Similarly, if the DMA controller 26 returns the executed data processes to the main system 10, the accessed data processes are arranged in the job queue controller 24 according to a sequence, and the job queue controller 24 will notice the transmitter controller 23. In the meantime, the DMA controller 26 will drive the DMA controller 26 to transmit the data to the transmitter controller 23 and respond to main system 10 to write the processed data into the connected storage device based on the transfer address and the transfer count described by the PRD table controller.

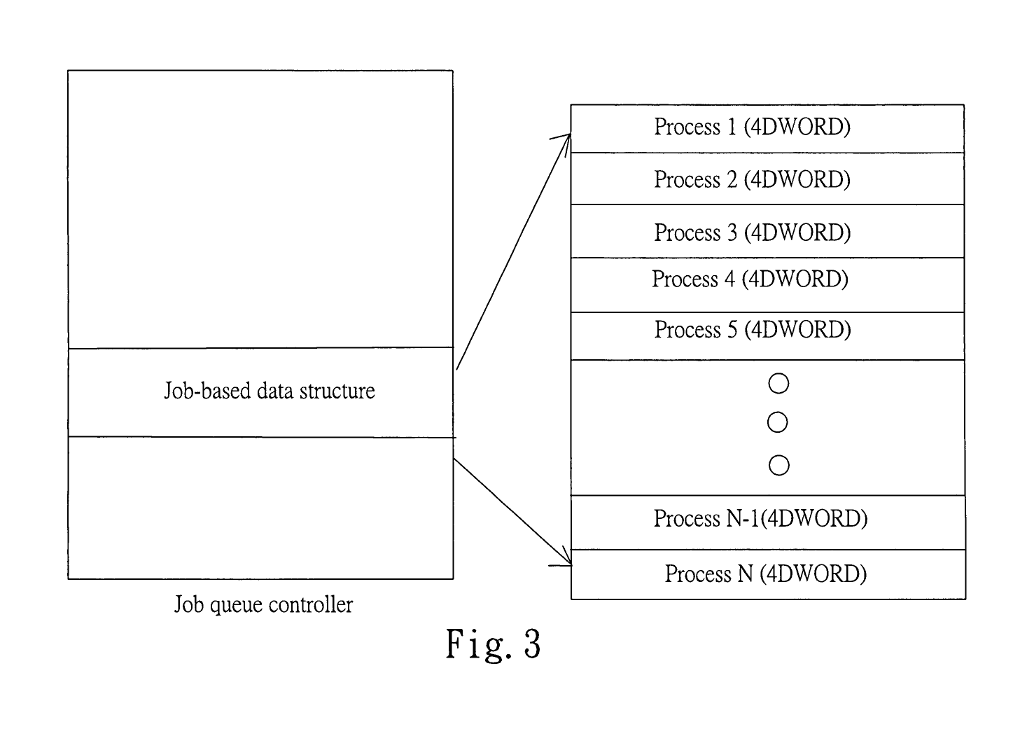

With reference to FIG. 3, the present invention decomposes an instruction transmitted from the main system into a plurality of instruction processes or decomposes a data processed by the DMA controller 26 into a plurality of data processes in the job queue controller 24 according to a sequence, and transmits the processes to the main system and/or the DMA controller 26 based on a first-in-first out FIFO basis, and the format of the processes in this embodiment is a 4DWORD type.

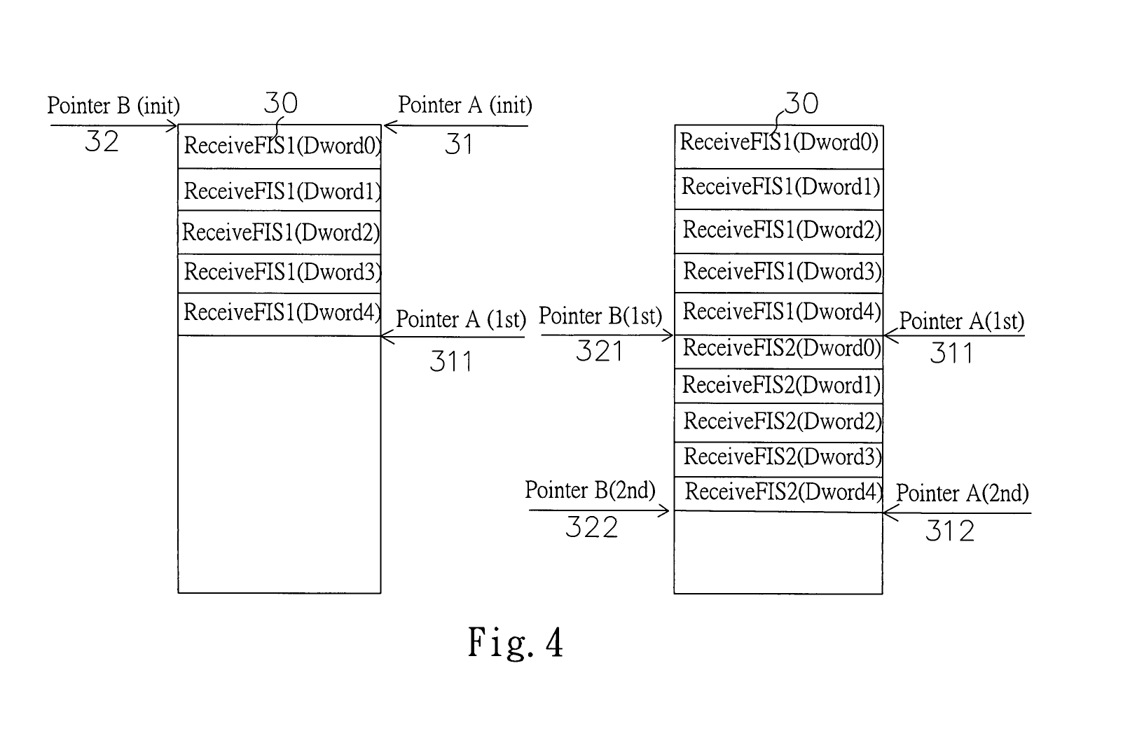

Referring to FIG. 4 for a schematic view of processing a data in the frame information structure (FIS) format transmitted from the interface controller 11 by a receiver controller 22 according to the present invention, the data in frame information structure (FIS) format can be an instruction transmitted from the main system, and the receiver controller 22 includes a memory space 30, and the memory space 30 includes pointers A and B 31, 32, and the pointer A 31 indicates the total number of frame information structures (FIS) in the memory space 30, and the pointer B 32 indicates the executing position in the memory space 30. At the beginning of the operation, the pointers A and B 31, 32 have the same values, but after the first frame information structure (FIS) is transmitted to the receiver controller 22 through the interface controller 11 and gone through a coding procedure by the codec 21, the receiver controller 22 will update the total number of frame information structures (FIS) to be the pointer A 311. Now the pointer B 32 will point to the executing position of the pointer B 321. In the meantime, when the receiver controller 22 receives a second frame information structure (FIS), the pointer A 31 in the memory space 30 will be updated to the pointer A 312. In the meantime, the pointer B 321 will point to the position of the pointer B 322, and so forth.

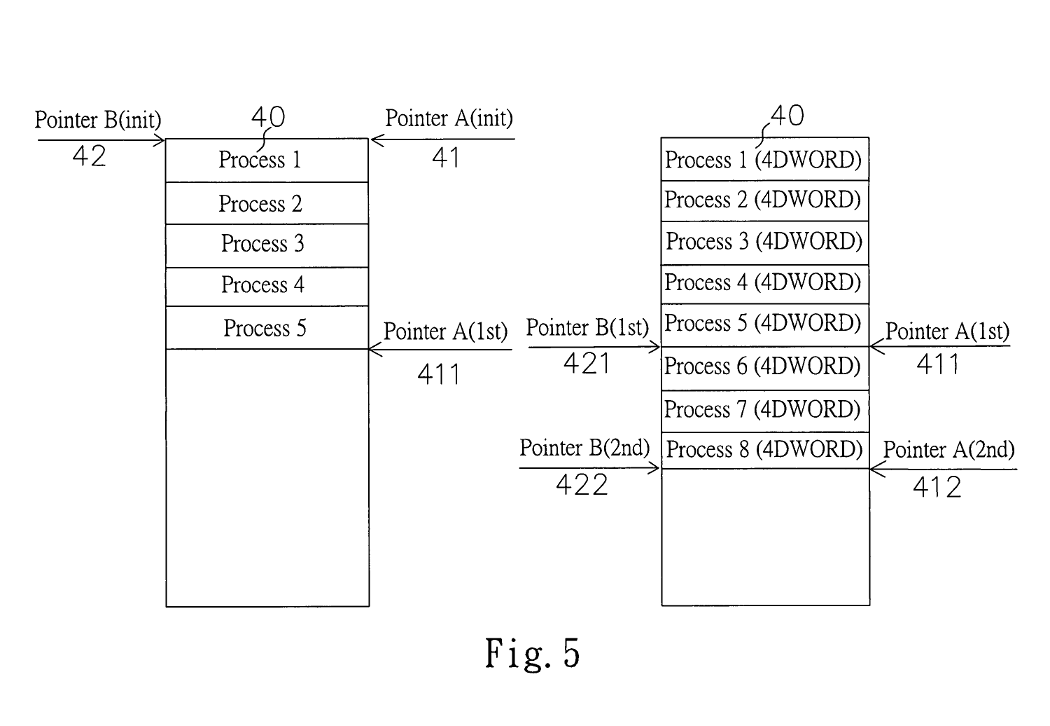

Referring to FIG. 5 for a schematic view of operating a job queue controller 24 according to the present invention, the job queue controller 24 includes a job queue memory space 40, and the job queue memory space 40 includes pointers A and B 41, 42, and the pointer A 41 in the job queue memory space 40 is pointed to the total number of data of the main system, and the pointer B 42 is pointed to the completed processes in the job queue memory space 40. At the beginning of the operation, the pointers A and B 41, 42 are initialized, but when the processed executed by a program is transmitted to the job queue controller 24, the job queue controller 24 will update the total number of the processes to the pointer A 411. Now, the program continues executing the processes in the queue one by one. In the meantime, each executed process will have its independent frame information structure, and the transmitter controller 23 is noticed to transmit the executed processes to the main system 10. After the program has executed the aforementioned processes, the pointers A and B 411, 421 will be equal. In the meantime, if the program continues executing a new job, then the pointer A 411 in the job queue memory space 40 will be updated to 412. In the meantime, the program will execute and update the pointer B 421 to the pointer B 422, and so forth.

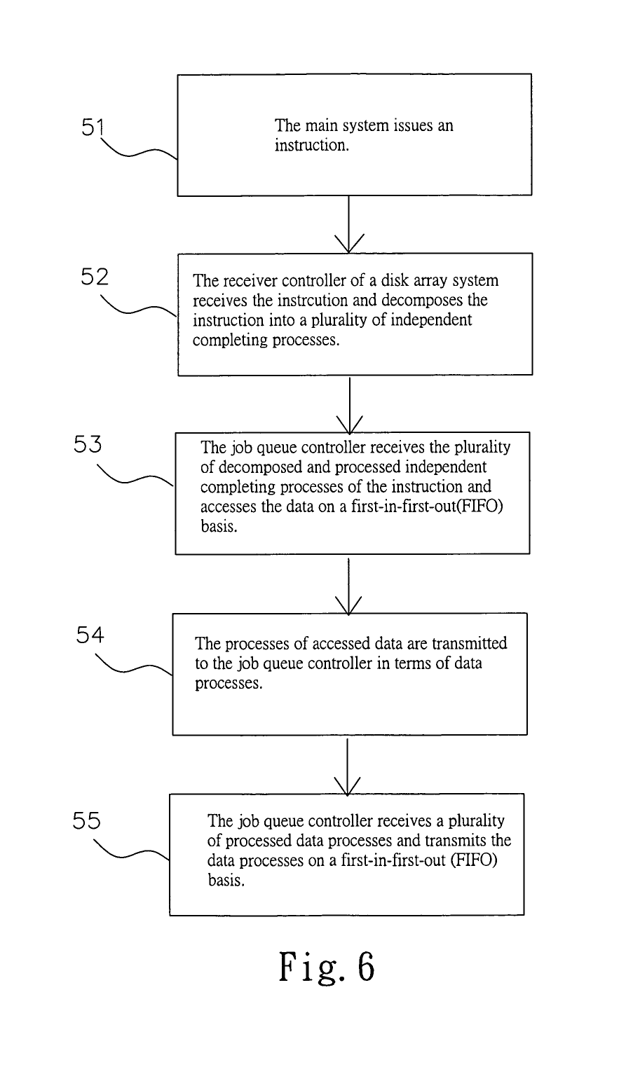

Referring to FIG. 6 for a flow chart of an operation using a process as a data processing and transmission unit, the operation comprises the following steps:

Step 51: The main system issues an instruction.

Step 52: The receiver controller of a disk array system receives the instruction and decomposes the instruction into a plurality of independent completing processes.

Step 53: The job queue controller receives the plurality of decomposed and processed independent completing processes of the instruction and accesses the data on a first-in-first-out (FIFO) basis.

Step 54: The processes of accessed data are transmitted to the job queue controller in terms of data processes.

Step 55: The job queue controller receives a plurality of processed data processes and transmits the data processes on a first-in-first-out (FIFO) basis.

The present invention decomposes the instruction into a plurality of independent completing processes, and uses the process as the data processing and transmission unit without requiring to start returning to the main system after all processes in the instruction have completed in accordance with the prior art, and the invention also reduces the waiting time for the completion of the instruction processes and thus greatly improving the operating efficiency of the main system.

In summation of the above description, the present invention herein enhances the performance of the conventional structures and further complies with the requirements of patent application and is thus duly filed for the patent application.

While the invention has been described by means of specific embodiments, numerous modifications and variations could be made thereto by those skilled in the art without departing from the scope and spirit of the invention set forth in the claims.

What is claimed is:

1. A job-based structure using a process as a data processing and transmitting unit, comprising:
a main system, further comprising:
a system processor, for issuing a data access request according to a desired executing instruction;
a system memory, for storing a processed data;
a disk array system, electrically coupled to said main system, for accessing data according to said desired executing instruction of said system processor, and said disk array system further comprising:
a receiver controller, for receiving an instruction from said main system, and decomposing said instruction into a plurality of independently completing processes as execution units;
a transmitter controller, for responding an accessed data to said main system by using said process as a unit;
a job queue controller, for receiving a desired executing process of an instruction or a processed data transmitted from said receiver controller, and returning to said transmitter controller according to a sequence;
a PRD table controller, for describing a transfer address and a transfer count of desired processing instruction and data;
a DMA controller, further comprising a DMA bus, and said DMA controller witting said desired executing instruction process arranged by said job queue controller into said DMA bus according to a description of said PRD table controller to start accessing data or transmitting said processed data process to said job queue controller through said description of said PRD table controller.

2. The job-based structure using a process as a data processing and transmitting unit according to claim 1, wherein said main system installs an interface controller thereon, and said main system is electrically coupled with said disk array system through said interface controller.

3. The job-based structure using a process as a data processing and transmitting unit according to claim 2, wherein said interface controller supports a Serial ATA communication interface.

4. The job-based structure using a process as a data processing and transmitting unit according to claim 1, wherein said disk array system includes a codec, and said codec performs a coding/decoding procedure for said instruction transmitted from said main system or said data returned to said main system according to an 8b/10b coding mechanism.

5. The job-based structure using a process as a data processing and transmitting unit according to claim 1, wherein said disk array system includes a storage device, and said storage device supports a native instruction queuing (NCQ) protocol.

6. The job-based structure using a process as a data processing and transmitting unit according to claim 1, wherein said job queue controller executes an arranged job-based on a first-in-first-out (FIFO) basis.

7. A method of executing a job-based data processing and transmitting unit installed in a main system and a disk array system, and said main system including a system processor and a system memory, and said disk array system including a receiver controller, a transmitter controller, a job queue controller, a PRD table controller and a DMA controller, and said method comprising the steps of:
(1) issuing an instruction by said main system;
(2) receiving and dissembling said instruction into a plurality of independently completing job-based units by said receiver controller of said disk array system;
(3) decomposing said received plurality of independently completing instruction processes and accessing data on a first-in-first-out (FIFO) basis by said job queue controller;
(4) transmitting data of an accessed process to said job queue controller in terms of a process
(5) receiving said plurality of processed processes of said data and transmitting said data to said main system according to the sequence of said processes of said data.

8. The method of executing a job-based data processing and transmitting unit according to claim 7, wherein said job-based format is in a 4DWORD type.
